(19) United States
(12) Patent Application Publication
(10) Pub. No.: US 2005/0115216 A1
(43) Pub. Date: Jun. 2, 2005

(54) Filter element with hydrophobic properties

(75) Inventors: Sascha Bauer, Auenwald (DE); Michael Fasald, Auenwald (DE); Jochen Linhart, Waiblingen (DE); Peter Mueller, Saarbruecken (DE); Alrun Spennemann, Stuttgart (DE); Holger Findeisen, Freiberg (DE)

Correspondence Address: CROWELL & MORING LLP;INTELLECTUAL PROPERTY GROUP, P.O. BOX 14300, WASHINGTON, DC, 20044-4300, US

(73) Assignee: Mann+ Hummel GmbH, Ludwigsburg (DE)

(21) Appl. No.: 10/866,105

(22) Filed: Jun. 14, 2004

(30) Foreign Application Priority Data
Jun. 12, 2003 (DE) DE10326363.2

(51) Int. Cl. B01D 46/00

(52) U.S. Cl. 55/524

(57) ABSTRACT

A filter element having hydrophobic properties for separating solid and/or liquid particles from fluid media, in which the filter medium is provided with an inorganic nonmetallic coating, in particular a silicate coating, in order to provide or create and impregnated, hydrophobic surface.

### BACKGROUND OF THE INVENTION

This invention relates to a filter element for separating solid and/or liquid particles from fluid media comprising at least one filter medium with hydrophobic characteristics. The invention additionally relates to a filter housing for accommodating the aforementioned filter element.

Filter elements of this type are used wherever there is the risk of water entering the filter element and therefore a risk of softening and consequently a static instability of the filter element. A filter element having a media-permeable supporting layer on the discharge side of the filter medium is known from the prior art. In the case of softening of the filter element, the filter medium is forced with the flow toward the supporting layer, so that destruction of the filter medium can be delayed or prevented, depending on the quantity of water which is present. One disadvantage of this approach is the additional supporting layer required, which must be made of a material having static resistance, usually a metal. This results in higher expenses in the production process due to a greater cost of materials as well as a greater weight of the filter.

An improved stabilization of the filter medium is disclosed in Japanese Patent 2003-210921, which relates to a multilayer filter medium, in which individual layers are formed from water-repellent fibers. The arrangement of multiple layers requires a greater material complexity and process complexity in manufacturing and thus also results in higher costs.

### SUMMARY OF THE INVENTION

The object of the present invention is to provide a filter element which retains its static stability even when water is present in the fluid to be filtered.

A further object of the invention is to provide a filter element which is easy to manufacture.

Another object of the invention is to provide a filter element which does not pose additional restrictions with regard to flow resistance, weight or handling.

Yet another object of the invention is to provide a filter element which forms a water barrier for entrained water within the fluid to be filtered.

These and other objects are achieved in accordance with the present invention by providing a filter element for separating solid or liquid particles from a fluid medium, said filter element comprising at least one filter medium having hydrophobic properties; wherein the filter medium is a paper that has been treated by an inorganic, non-metallic impregnation so as to have water-repellent properties.

The filter element according to the invention for separating solid particles and/or liquid particles from a fluid medium, in particular a gaseous medium, especially intake air for an internal combustion engine, preferably uses paper as the filter medium which is treated with an inorganic, nonmetallic impregnation, in particular with a silicate. The filter element is likewise suitable, for example, for filtering oils or fuels for an internal combustion engine. Additional examples of suitable filter media include synthetic or semi-synthetic filter materials or renewable raw materials such as coconut fibers, hemp or wool as well as all other filter media known in the art. The feed or inlet side with regard to the fluid to be filtered is preferably impregnated. This impregnation may be based on an aqueous system and/or an alcohol-based system. The impregnation is preferably performed according to the sol-gel method using a modified silicon oxide, preferably SiO₂. For example, the Mincor product available from BASF is a suitable example. A uniform, thin-layer surface, closed but nevertheless permeable to fluid particles, surrounds the fibers of the medium with ultrafine particles, preferably nanoparticles, on the surface of the filter medium. The filter medium is preferably surrounded by a dense contour which in turn corresponds to a contour of a housing part and therefore separates a feed or inlet side from a discharge side with a seal. The surrounding sealing contour may be made of an elastomer such as polyurethane foam, sponge rubber or silicone rubber or a fibrous material such as felt or paper as well other sealing materials known in the art.

The impregnation allows the medium to be filtered to flow through the filter in an advantageous manner, while the water molecules and/or particles are held back on the filter medium. On feed or inlet surface of the filter medium, the water forms droplets which cannot become attached to the medium, penetrate therethrough or soften the medium. The fluid to be filtered passes through the filter medium without undergoing any significant change in flow resistance. This water-repellent property increases the stability of the filter element in an extremely advantageous manner. Since a filter element is subjected to a large pressure drop in the fluid flowing through it, an uptake of water into the filter medium always causes a weakening of the ability of the filter element to withstand the pressure drop of the flowing fluid. Since the filter element treated according to this invention does not allow essentially any uptake of water, the integrity of the filter element is therefore maintained. This impregnation may be performed with any standard filter element so that this represents an inexpensive way of preventing water-induced damage to the filter element and the air consuming device connected downstream of the filter. Thus existing filter systems can also be easily retrofitted in an advantageous manner without redesigning individual features.

Another advantage results from the increased thermal stability due to the impregnation, which leads to an increase in the flash point and reduces the risk of fire. When the filter element is used in an air filter system for an internal combustion engine, it may happen that a fire source is drawn directly into the intake side of the air filter element due to a discarded cigarette, for example. However, the fibers of the filter medium, enclosed with the ultrafine particles, preferably nanoparticles, have the advantage of a higher flash point than the untreated medium. This in turn leads to a cost reduction because otherwise an additional design measure is necessary in high-risk areas of use. This avoids, for example, the potential fire risk due to intake of smoldering cigarettes.

In comparison with corrosive ambient media, e.g., due to backflow of unburned HC gases from the intake tract of an internal combustion engine during a shutdown in operation or due to the introduction of oil-laden gases, the coating has a high resistance to aggressive ambient conditions. Likewise, it also has a better stability with respect to the sometimes aggressive additives in the new light-running oils and/or various fuels. The static stability is permanently ensured due to the impregnation so that the service life of the filter medium is prolonged.

In one advantageous embodiment of this invention, the filter element has a zigzag pleated filter medium, where the pleated form encloses a cylindrical, oval or polygonal hollow ring. The ends of the zigzag pleating are in this case tightly sealed, and an end disk is provided on at least one end, serving to provide a tight separation between the unfiltered fluid side on the inlet end and the filtered fluid side on the discharge end. The discharge end is preferably located at a higher level geodetically, so that the repelled water can flow into the geodetically lower region because of its greater density. A second end of the filter element may be sealed by a closed end disk or by a connection to the filter housing. The hollow cylindrical filter element may also be adapted to the diameter of a flow cross section and integrated as an inline filter. The pleating makes it possible to accommodate a large filter area in a relatively small space and thus to minimize the installation space of the filter element.

In another advantageous embodiment, the filter element has a coiled or wound filter medium. Such filter elements consist either of rolled up paper with groove-like pleating, with the paper being rolled up parallel to the axis of the grooves and the flow passing through such elements axially or consisting of filter media rolled up in a ring, resulting in multiple layers due to being rolled up with the flow passing through them radially. The flow channels formed in the grooves of the filter elements through which the filter medium flows axially are alternately sealed at the ends. On the peripheral surface of the coiled filter element, a sealing contour communicating with the connecting flange of a filter housing must be formed. Due to the compact design of the coiled filter element, it is also possible to create a relatively large filter area even in very small flow cross sections. This is made possible due to the fact that no discharge cross section needs to be present at the center, and the fluid is guided axially through the filter medium. The design of the coiled filter element, also known as a compact filter, is especially suitable for integration into a tubular cross section as an inline filter.

The second possibility for forming a coiled element consists of coiling a filter medium in a spiral around hollow space. In this case, the filter medium forms a ring-shaped multilayer lateral surface through which the fluid to be filtered flows, preferably radially from the outside to the inside.

Preferred materials for the filter media include synthetic nonwoven materials, but all filter media known in the art may also be used. Sheets of filter media may be coiled up directly and do not need any complex geometric structure, which is why this type of coiled filter can be produced inexpensively by simple methods.

In another advantageous arrangement, the filter element according to the invention is constructed as a flat filter element where the filter medium is folded in a plane and the side edges of the paper must be tightly sealed by gluing. The tips of the folds here face the feed or inlet side on one side and are opposite the discharge side. The folds may be in the form of pleats or they may be rounded. The filter medium is preferably surrounded by a peripheral contour that is sealed toward the side edges on the discharge side with the peripheral contour corresponding to a contour of the filter housing. The flat filter element is suitable for advantageous use in all cases where a wide but flat installation space is available. However, with flat filter elements, it is especially difficult to assure adequate stability, e.g., in pressure pulsation. If in addition to pressure pulsation or a large pressure drop, there is also softening of the filter medium, this will very rapidly result in tearing of the filter medium due to the large filter area exposed to the flow. Impregnation of the feed or inlet side of flat filter elements has proven to be a simple but extremely advantageous way of assuring the stability of the filter element when water particles are present in the fluid to be filtered.

It is advantageous to apply the impregnation of the filter element by methods that are widely used in the coating technology such as spraying, rolling or dipping. The filter medium, which is composed of solid substances, is partially or completely wetted or impregnated by the impregnating agents present in liquid form. Flat filter media are suitable for all coating methods. Folded or pleated media are preferably coated by a dipping method with two-sided coating being possible in one process step. Since most filter elements have a surrounding contour, the coating may also take place even after this contour is applied; in this case a spray application of the coating is advisable.

In a preferred procedure, the applied impregnation is treated with a heating process or UV radiation to accelerate curing and crosslinking. The curing time at approximately 15° C. may be several weeks and is shortened to approximately two minutes at a temperature of approximately 150° C. Depending on the cycle time of the manufacturing process, the curing time may be determined by the choice of the temperature. Since the fabrication process of the paper after folding or pleating also includes a curing time, the two curing processes may preferably intersect or overlap and thus the coating may be applied before curing of the paper or some other filter medium. This advantageously shortens the manufacturing process and increases the productivity of the manufacturing plant accordingly. A longer curing time does not have any negative effect on the properties of the impregnated surface, which is why a storage time may also be used for the curing process. Because of the chemical nature of the impregnation, the curing process may also be interrupted and continued with over time so that it is also possible to first temporarily store the filter elements so that a certain autonomous curing takes place during the intermediate storage and then the filter elements are conditioned after storage and shortly before use by an appropriate temperature or UV treatment so that the curing process is concluded.

Other advantages are derived from the use of the filter element for filtering gaseous media. Possible areas for use include, for example, interior air filters for passenger compartments of vehicles or for the cabs of trucks and the like, filter systems in the intake tract of internal combustion engines, air filter systems for the air intake of compressors, particularly in elements for removing oil from air, interior filters for movable containers, air drying systems in particular for dehumidifying the air of commercial vehicles, compressed air brakes, water separators in vacuum pumps or for general gas filtration, wherever the admission of water into a filter element or the downstream consumer is to be prevented. Based on its resistance to aggressive substances, the inventive filter element can be used in a broad spectrum of applications.

It is also advantageous to use the inventive filter element for filtration of liquid media. In such cases it is possible to filter out and retain aqueous components, e.g., from fuels, lubricants or operating fluids. A typical application arises in the fuel systems of internal combustion engines, where there is a danger that water present in the fuel tank or in the delivery system may become entrained in the flow of fuel. By using the inventive filter element in existing fuel filters, the presence of aqueous components in downstream units is prevented. Especially in sensitive filter systems, it is extremely important to keep water away from the sensitive parts. The use of filter elements impregnated and treated according to this invention can successfully prevent the corrosion damage and gasket damage which occur due to the presence of water.

In one advantageous embodiment of this invention, the filter element according to the invention is used as a filter element for filtering gaseous media and is introduced with a seal into a housing which is also treated with the inorganic, non-metallic impregnation, in particular a silicate impregnation. This combination is particularly recommended for an air filter system because the separated water can be discharged directly into the environment on the unfiltered air side of the filter. The filter housing is manufactured, for example, by an original shaping method, preferably by injection molding or by a rotary casting method or as a blow-molded part and is formed from a polymer. In the injection molding process, the hydrophobic impregnation of the housing side may be applied, for example, by spraying it onto the mold, so it becomes attached to the housing as the polymer cures.

The impregnating coating on the housing may also be produced on both sides by dipping or spraying. The housing may be constructed in one or more parts, in which case the individual parts are welded together, glued or joined by other methods. The filter housing has an inside surface facing the filter medium on the feed or inlet side and one the discharge side. The filter element is introduced with a seal between the inlet side and the discharge side. Water entering the air filter system also comes in contact with the inside surface of the feed or inlet side of the housing. The water rejected by the filter medium is removed through the feed or inlet side of the filter. This may take place when the velocity of flow of the fluid to be filtered is reduced or when the fluid is at a standstill. The water is drained preferably through an opening provided at a geodetic low point, with the fluid to be filtered flowing from bottom to top. The discharge of accumulated water is accelerated because the hydrophobic impregnation of the interior surfaces of the housing on the feed or inlet side prevents the water from finding any surface for adhesion.

Additional details of this invention are illustrated in the drawings and described with reference to the drawing figures.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a schematic, cross-sectional view of an air filter according to the invention;

FIG. 2 is a schematic view of an air filter element according to the invention;

FIG. 3 is an enlarged diagrammatic view showing the fiber arrangement in the edge area of a filter medium, and

FIG. 4 is a greatly enlarged detail view of the edge area of a filter medium showing the fiber pattern.

### DETAILED DESCRIPTION OF PREFERRED EMBODIMENTS

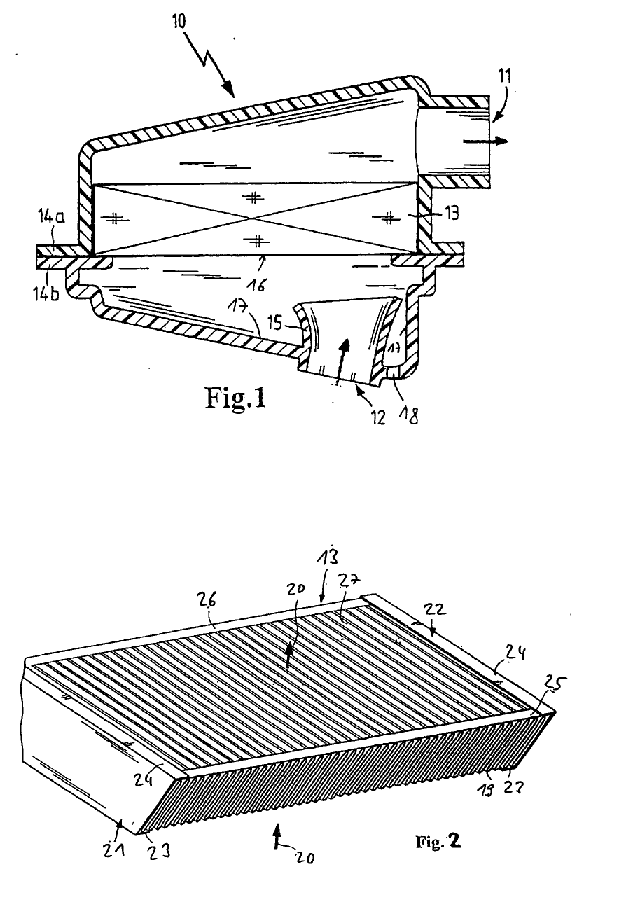

FIG. 1 shows an air filter 10 with an outlet 11 and an inlet 12. An air filter element 13 is sealingly arranged between outlet 11 and inlet 12 so that air from the inlet 12 must flow through the filter element 13 to reach the outlet 11. The air filter 10 is composed of two air filter housing parts 14a, 14b which are detachably joined together with a seal. The outlet 11 and the inlet 12 (the arrows indicate the direction of flow) offer a possibility for connecting additional lines and/or components to the air filter housing.

The housing walls on the air filter housing part 14b may be continued or extended in a convex pattern into the interior of the air filter 10 in the vicinity of the inlet 12 and thereby form a receiving connection 15. This means that the continuous area becomes larger toward the inside in the direction of the interior of the air filter 10, starting from the exterior end of the inlet 12. The receiving connection 15 has an essentially circular base area. In the configuration shown here, this air filter 10 is directly insertable into an internal combustion engine.

The impregnation and/or treatment of the air filter element 13 and/or a housing interior wall were performed on the feed or inlet side 16 of the filter element 13 and likewise on the interior wall 17 of the housing on the feed or inlet side of the filter element 13. At the geodetically lowest point, the housing 14b has a through-opening 18 for the water repelled by the filter element 13. The water is repelled by the impregnated feed or inlet side 16 of the filter element 13 and runs down along the interior wall 17 of the housing, which has likewise been treated, flowing to the lowest point in the filter housing part 14b from which it can then flow out through the outlet opening 18.

FIG. 2 shows a flat filter element 13 for an air filter according to FIG. 1. The parts corresponding to those in FIG. 1 are identified by the same reference numerals. The air filter 10, for example, is suitable for filtering the air in the air intake tract of a motor vehicle. The filter element 13 in this illustrative embodiment comprises a zig-zag folded paper filter sheet 19 through which the air to be filtered passes as indicated by arrows 20. The outside edges of the paper filter sheet 19 are completely glued together forming a seal to prevent any escape of air through the outside edges. To do so, a strip of glue is applied to the outside edges of the paper sheet 19, e.g., before folding, and the sheet is then folded in zigzag pleats so that the ends are sealed together.

On opposing ends the filter element 13 has edge elements 21 and 22, likewise made of paper, folded over at the ends 23 and 24 to form the filter sheets 19 and then glued to them. On the other edges of the filter element 13, paper strips are glued to the surface 27 of the filter element 13 as edge elements 25 and 26. The folded over ends 24 and the edge elements 25 and 26 here also serve as the sealing surface when the filter element 13 is secured in a filter housing. The inventive impregnation which is applied on the feed or inlet side, i.e., beneath the filter element 13, is preferably applied by spraying before folding the paper and may then be cured in a subsequent oven curing operation after the paper is folded.

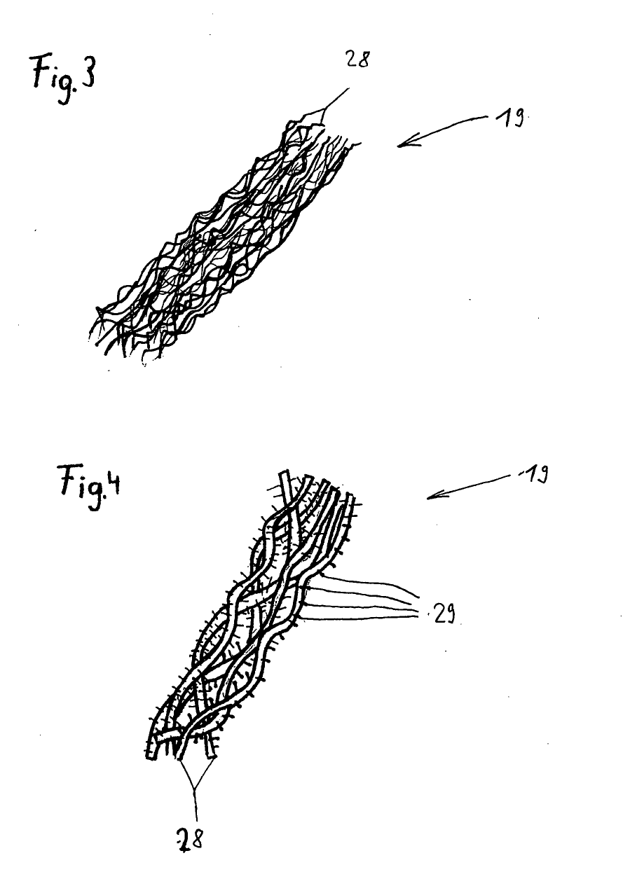

FIG. 3 shows the fiber pattern in the edge area of a filter sheet 19 in an enlarged diagram. Parts corresponding to those in the previous figures are identified by the same reference numerals. In this enlarged detail view of a filter sheet 19, it can be seen that the filter element does not consist of a homogeneous mass but instead consists of individual fibers 28 woven together and aligned preferably in the direction of the filter sheet 19. Due to the position of the entangled fibers 28 in relation to one another, strengthening of the fiber bundle is achieved.

FIG. 4 shows a greatly enlarged detail of the edge area 16 on the feed or inlet side of a single filter sheet 19. Once again, parts corresponding to those in the previous figures are identified by the same reference numerals. The fibers 28 present in the area near the surface on the feed or inlet side of the filter sheet 19 have ultrafine particles, preferably nanoparticles 29 due to the inorganic but nonmetallic impregnation, in particular the silicate impregnation on the individual fibers. These ultrafine particles 29 cure under the influence of temperature and/or UV, becoming permanently attached to the fibers 28. Due to the very small size of the ultrafine particles 29, it is now possible to retain and coalesce the oncoming water flow in the molecular range and to prevent the water from passing, whereas the fluid to be filtered (namely the intake air here) is allowed to pass through the filter element 19 unhindered. As can be seen here, the ultrafine particles 29 are deposited like tiny hairs on the individual fibers 28. It is functionally sufficient for an inexpensive production of the filter elements to provide fibers 28 only on the feed or inlet side with the impregnation. However, it is also possible to impregnate all the fibers of each paper sheet with the coating medium, preferably a sol or a lacquer.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A filter element for separating solid or liquid particles from a fluid medium, said filter element comprising at least one filter medium having hydrophobic properties; wherein the filter medium is a paper that has been treated by an inorganic, non-metallic impregnation so as to have water-repellent properties.

2. A filter element according to claim 1, wherein said impregnation is a silicate impregnation.

3. A filter element according to claim 1, wherein the filter element comprises a hollow cylindrical filter medium pleated in zig-zag pleats and tightly sealed at its axial ends.

4. A filter element according to claim 1, wherein the filter element comprises a filter medium coiled into a hollow cylinder.

5. A filter element according to claim 1, wherein the filter element comprises a flat filter medium.

6. A filter element according to claim 1, wherein the impregnation is applied by spraying, rolling or immersing.

7. A filter element according to claim 1, wherein the impregnation is cured or crosslinked by a thermal treatment or UV radiation.

8. A filter element according to claim 1, wherein the filter element is a gas filter.

9. A filter element according to claim 8, wherein the filter element is an air filter.

10. A filter element according to claim 1, wherein the filter element is a liquid filter.

11. A filter element according to claim 10, wherein the filter element is a fuel filter.

12. A filter housing for a filter element as claimed in claim 7, wherein the filter housing has a housing interior surface at least a portion of which has hydrophobic properties; the filter element is arranged in the filter housing with a seal between an inlet side and a discharge side, and the impregnation of the filter element is situated at least partially on the inlet side.
